(19) United States
(12) Patent Application Publication
(10) Pub. No.: US 2023/0164039 A1
(43) Pub. Date: May 25, 2023

(54) User Feedback for Learning of Network-Incident Severity

(71) Applicant: ARRIS Enterprises LLC, Suwanee, GA (US)

(72) Inventor: Maitreya Vadlamani, Singapore (SG)

(73) Assignee: ARRIS Enterprises LLC, Suwanee, GA (US)

(21) Appl. No.: 18/056,896

(22) Filed: Nov. 18, 2022

Related U.S. Application Data
(60) Provisional application No. 63/281,866, filed on Nov. 22, 2021.

(51) Int. Cl. H04L 41/5067; H04L 41/0604; H04L 41/14; H04L 41/5009; H04L 41/16

(52) U.S. Cl. CPC H04L 41/5067; H04L 41/0609; H04L 41/145; H04L 41/5009; H04L 41/16

(57) ABSTRACT

A computer system that updates a pretrained predictive model is described. During operation, the computer system may receive, from an electronic device, information specifying user feedback about a network incident. Then, the computer system may update, based at least in part on the user feedback, the pretrained predictive model that outputs severity classifications of network incidents, where a difference between a severity classification of the updated pretrained predictive model and a user severity classification associated with the user feedback is reduced relative to an initial difference between an initial severity classification of the pretrained predictive model and the user severity classification. Moreover, the computer system may receive information specifying a second network incident. Next, the computer system may compute a second severity classification of the second network incident using the updated pretrained predictive model.

### CROSS REFERENCE TO RELATED APPLICATIONS

This application claims priority under 35 U.S.C. 119(e) to U.S. Provisional Application Ser. No. 63/281,866, “User Feedback for Learning of Network-Incident Severity,” filed on Nov. 22, 2021, by Maitreya Vadlamani, the contents of which are herein incorporated by reference.

### FIELD

The described embodiments relate to techniques for classifying network-incident severity.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless network.

Networks that include electronic devices routinely suffer from network incidents that adversely impact communication performance. For example, a network incident may include: an access-point connection failure, a failure of a computer network device (such as a switch or a router), a virtual local area network (VLAN) mismatch failure, or another type of network incident.

In order to address network incidents with the correct priority, it is typically helpful to classify the severity of a given network incidents. For example, network incidents that take the most time to address, that undermine trust in products or that significantly degrade communication performance may be classified as ‘worst’ and may be accordingly prioritized for remedial action by network operators.

However, the severity or importance of a given network incident often is a function of perspective. Notably, network operators usually have a different perspective or assessment of the severity of a given network incident than users of a network. This difference in perspective can result in different priorities for the network incidents. Consequently, network incidents that are less important to the users may be addressed before the network incidents that are important to the users, which may frustrate the users and degrade the user experience when using networks.

### SUMMARY

In a first group of embodiments, a computer system that updates a pretrained predictive model is described. This computer system includes: an interface circuit that communicates with an electronic device; a computation device; and memory that stores program instructions, where, when executed by the computation device, the program instructions cause the computer system to perform operations. Notably, during operation, the computer system receives, from the electronic device, information specifying user feedback about a network incident (e.g., the network incident may have adversely impacted communication performance in at least a portion of a network). Then, the computer system updates, based at least in part on the user feedback, the pretrained predictive model that outputs severity classifications of network incidents, where a difference between a severity classification of the updated pretrained predictive model and a user severity classification associated with the user feedback is reduced relative to an initial difference between an initial severity classification of the pretrained predictive model and the user severity classification.

Moreover, the computer system may receive information specifying a second network incident. Next, the computer system may compute a second severity classification of the second network incident using the updated pretrained predictive model. Furthermore, the computer system may determine a priority on the second network incident based at least in part on the second severity classification. Additionally, the computer system may perform a remedial action based at least in part on the second severity classification and/or the priority. For example, the remedial action may include: changing a network configuration, correcting a component failure in the network (such as a failure of an access point or a computer network device, e.g., a switch or a router), correcting a VLAN mismatch failure, and/or otherwise correcting the second network incident. In some embodiments, the computer system may compute a third severity classification of the second network incident using a general pretrained predictive model that is associated with multiple users, and the priority and/or the remedial action may be based at least in part on the third severity classification.

Note that the pretrained predictive model and/or the updated pretrained model may include: a neural network, a supervised machine-learning model, and/or another type of predictive model. In some embodiments, the pretrained predictive model and/or the updated pretrained predictive model may include a classifier or a regression model. Consequently, a given severity classification may include categorical information or numerical values (such as numerical values between 0 and 1).

Moreover, the user feedback may include: a score or a ranking corresponding to the user severity, a scope of the network incident, a type of the network incident, a physical location in the network of the network incident, and/or a hierarchical location in the network of the network incident (such as a system, a domain, a zone, affected network component(s), etc.).

Furthermore, the computation device may include a processor or a graphical processor unit.

Another embodiment provides a computer-readable storage medium for use with the computer system. This computer-readable storage medium may include program instructions that, when executed by the computer system, cause the computer system to perform at least some of the aforementioned operations.

Another embodiment provides a method. This method includes at least some of the operations performed by the computer system.

A second group of described embodiments relate to an electronic device. This electronic device includes an interface circuit that communicates with a computer system. During operation, the electronic device receives, from the computer system, information associated with a network incident in a network (e.g., the network incident may have adversely impacted communication performance in at least a portion of a network). Then, the electronic device presents the information (e.g., the information may be displayed in a user interface on a display). Moreover, the electronic device receives user-interface-activity information, wherein the user-interface-activity information specifies user feedback about a severity of the network incident. Next, the electronic device provides, addressed to the computer system, the user feedback.

Another embodiment provides a computer-readable storage medium for use with the electronic device. This computer-readable storage medium may include program instructions that, when executed by the electronic device, cause the electronic device to perform at least some of the aforementioned operations.

Another embodiment provides a method. This method includes at least some of the operations performed by the electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for updating a pretrained predictive model in the system in FIG. 1 in accordance with an embodiment of the present disclosure.

FIG. 3 is a flow diagram illustrating an example method for providing user feedback in the system in FIG. 1 in accordance with an embodiment of the present disclosure.

FIG. 4 is a drawing illustrating an example of communication among electronic devices in FIG. 1 in accordance with an embodiment of the present disclosure.

FIG. 5 is a drawing illustrating an example method for dynamically updating a predictive model in the system in FIG. 1 in accordance with an embodiment of the present disclosure.

FIG. 6 is a drawing illustrating an example of a user interface that receives user feedback about a network incident in accordance with an embodiment of the present disclosure.

FIG. 7 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that updates a pretrained predictive model is described. During operation, the computer system may receive, from an electronic device, information specifying user feedback about a network incident (e.g., the network incident may have adversely impacted communication performance in at least a portion of a network). Then, the computer system may update, based at least in part on the user feedback, the pretrained predictive model that outputs severity classifications of network incidents, where a difference between a severity classification of the updated pretrained predictive model and a user severity classification associated with the user feedback is reduced relative to an initial difference between an initial severity classification of the pretrained predictive model and the user severity classification. Moreover, the computer system may receive information specifying a second network incident. Next, the computer system may compute a second severity classification of the second network incident using the updated pretrained predictive model.

By updating the pretrained predictive model using the user feedback, the communication techniques may facilitate improved quality of service in the network. Notably, the updated pretrained predictive model may be more responsive to user needs, and thus may allow any remedial action to be more targeted to reflect the user needs and may be more-timely (so that the user is less affected by the second network incident). In addition, the user feedback may, at least in part, guide and/or improve the remedial action, such as by assisting in diagnosing the network incident or determining a location of the network incident. These capabilities may reduce user frustration and may improve the user experience when using networks.

In the discussion that follows, a ‘user’ may include: a network operator or administrator, an organization, a non-profit business, a for-profit business, a governmental agency, a group of individuals and/or an individual. Moreover, a ‘network incident’ may include one or more events that degrade or adversely impact communication performance in at least a portion of the network.

Furthermore, in the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Tex.), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station, a router or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

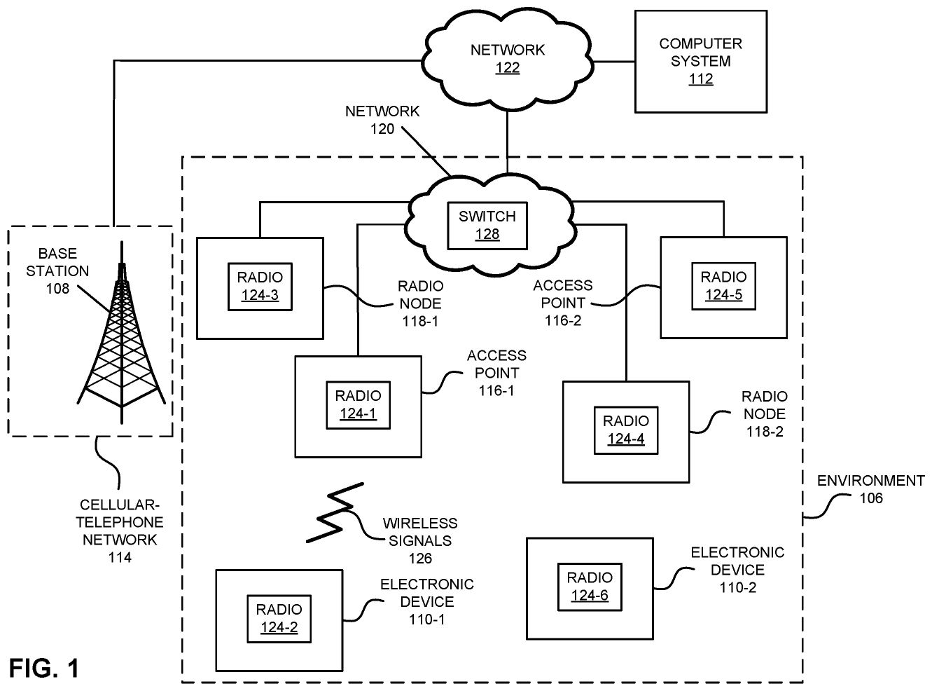

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device’ or a ‘computer network device.’ Moreover, as noted previously, one or more base stations (such as base station 108), access points 116, and/or radio nodes 118 may be included in one or more wireless networks, such as: a WLAN, a small cell, and/or cellular-telephone network 114. In some embodiments, access points 116 may include a physical access point and/or a virtual access point that is implemented in software in an environment of an electronic device or a computer.

Note that access points 116 and/or radio nodes 118 may communicate with each other and/or computer system 112 (which may be a controller that manages and/or configures access points 116, radio nodes 118 and/or switch 128, or one or more computers or servers that provide cloud-based storage and/or analytical services) using a wired communication protocol (such as Ethernet) via network 120 and/or 122. In some embodiments, computer system 112 may be at the same location as the other components in environment 106 or may be located remotely (i.e., at a different location).

Moreover, note that networks 120 and 122 may be the same or different networks. For example, networks 120 and/or 122 may an intra-net or the Internet. In some embodiments, network 120 may include one or more routers and/or switches (such as switch 128). While not shown in FIG. 1, there may be additional or different components or electronic devices.

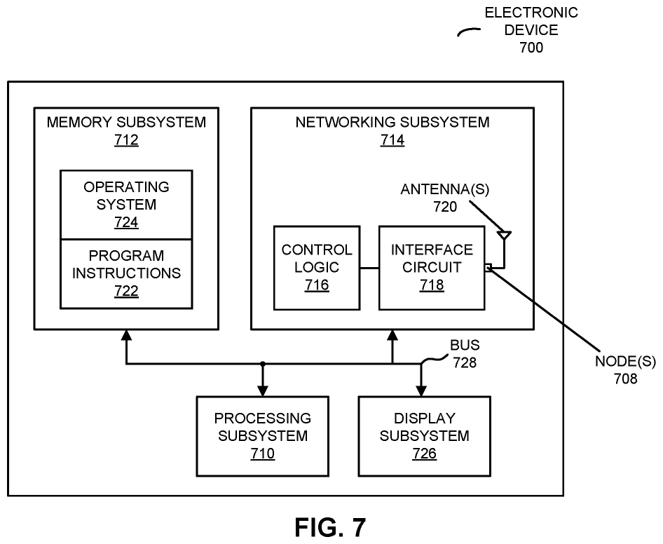

As described further below with reference to FIG. 7, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options (e.g., Internet Protocol Security), transmit and receive frames or packets via the connection, etc.

During the communication in FIG. 1, access points 116 and/or radio nodes 118 and electronic devices 110 may wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to calculate information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: a microwave frequency band, a radar frequency band, 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, the severity of a network incident may be in the eye of the beholder or the perspectives of a user. For example, a network operator administrator may view certain network incidents as more severe (and, thus, more important for remedial action) than other network incidents, while end users or individuals may have different ratings or classifications of severity for these network incidents. This can degrade the quality of service and user experience when using a WLAN, network 120 and/or network 122.

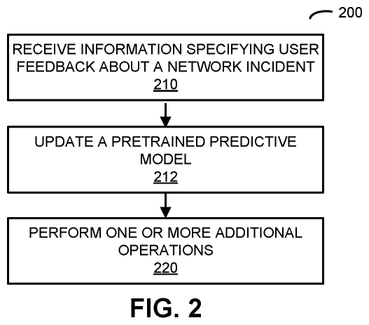

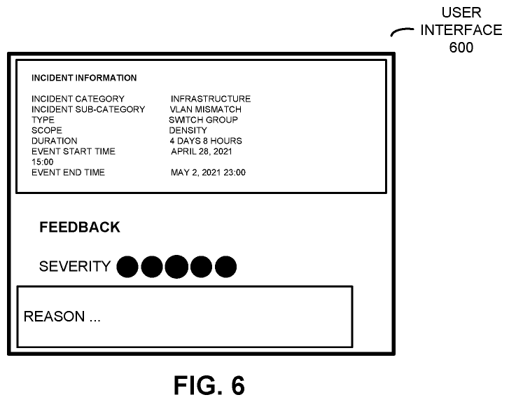

Moreover, as described further below with reference to FIGS. 2-6, in order to address these problems, a user of electronic device 110-1 may provide user feedback about one or more network incidents. For example, computer system 112 may provide information about one or more network incidents to electronic device 110-1. After receiving this information, electronic device 110-1 may present or provide the information to a user of electronic device 110-1. As described further below with reference to FIG. 6, the information may be displayed in a user interface.

Then, a user of electronic device 110-1 may provide user feedback about a severity of the one or more network incidents. For example, the user may provide the user feedback by interfacing with the user interface using a user-interface device (such as a touch-screen display, a keyboard, a mouse, a stylus, a touchpad, a voice interface, etc.). Note that the user feedback may include: a score or a ranking corresponding to the user severity, a scope of the network incident, a type of the network incident, a physical location in the network of the network incident, and/or a hierarchical location in the network of the network incident (such as a domain, a zone, affected component(s), etc.). After receiving user-interface-activity information that specifies the user feedback, electronic device 110-1 may provide the user feedback to computer system 112.

Next, after receiving the user feedback, computer system 112 may update, based at least in part on the user feedback, a pretrained predictive model that outputs severity classifications of network incidents, where a difference between a severity classification of the updated pretrained predictive model and a user severity classification associated with the user feedback is reduced relative to an initial difference between an initial severity classification of the pretrained predictive model and the user severity classification. (Overtime, the difference may approach zero, so that the severity classification of the pretrained predictive model and the user severity classification converge.) Note that the pretrained predictive model and/or the updated pretrained model may include: a neural network, a supervised machine-learning model, and/or another type of predictive model. In some embodiments, the pretrained predictive model and/or the updated pretrained predictive model may include a classifier or a regression model. Consequently, a given severity classification may include categorical information or numerical values (such as numerical values between 0 and 1).

Subsequently, computer system 112 may receive information specifying a second network incident. In response, computer system 112 may compute a second severity classification of the second network incident using the updated pretrained predictive model. Furthermore, computer system 112 may determine a priority on the second network incident based at least in part on the second severity classification. Additionally, computer system 112 may perform a remedial action based at least in part on the second severity classification and/or the priority. For example, the remedial action may include: changing a network configuration, correcting a component failure in the network (such as a failure of an access point or a computer network device, e.g., a switch or a router), correcting a VLAN mismatch failure, and/or otherwise correcting the second network incident. Alternatively or additionally, in some embodiments, computer system 112 may compute a third severity classification of the second network incident using a general pretrained predictive model that is associated with multiple users, and the priority and/or the remedial action may be based at least in part on the third severity classification.

Note that the pretrained predictive model may be pretrained or predetermined using a machine-learning technique (such as a supervised learning technique, an unsupervised learning technique and/or a neural network) and a training dataset with historical network incidents and their associated severity classifications. For example, the pretrained predictive model may include a classifier or a regression model that was trained using: a support vector machine technique, a classification and regression tree technique, logistic regression, LASSO, linear regression, random forests, a neural network technique (such as a convolutional neural network technique, a generative adversarial network or another type of neural network technique) and/or another linear or nonlinear supervised-learning technique. During operation, the pretrained predictive model may use attributes or characteristics associated with a network incident as an input and may output a severity classification of the network incident. In some embodiments, the pretrained predictive model may output additional information, such as a priority of the network incident and/or one or more recommended remedial actions. Moreover, while a single pretrained predictive model was used as an illustration of the communication techniques, in other embodiments there may be a group of pretrained predictive models, where a given pretrained predictive model in the group may be used to provide severity classifications for a subset of the network incidents or one or more types of network incidents in a subset of a network (such as a subnet or a zone) or the network as a whole. Alternatively or additionally, different pretrained predictive models may be used in environments associated with different vertical markets, such as education, hospitality, etc.

In these ways, the communication techniques may allow the pretrained predictive model to more accurate reflect the perspective of users. The pretrained predictive model may be dynamically updated to converge the severity classifications of the pretrained predictive model with the user severity classification corresponding to the user feedback. This capability may allow subsequent remedial action to better address the user needs and perspective. Consequently, the communication techniques may facilitate improved quality of service (such as improved communication performance for the users) and increased customer satisfaction.

While the preceding discussion illustrated the communication techniques using a local implementation (such as in computer system 112), in other embodiments the communication techniques may be implemented, at least in part, in a distributed manner (such as collaboratively by multiple access points 116).

We now describe embodiments of the method. FIG. 2 presents an example of a flow diagram illustrating an example method 200 for updating a pretrained predictive model. Note that method 200 may be performed by a computer system, such as computer system 112.

During operation, the computer system may receive, from an electronic device, information specifying user feedback about a network incident (operation 210). Note that the user feedback may include: a score or a ranking corresponding to the user severity, a scope of the network incident, a type of the network incident, a physical location in the network of the network incident, and/or a hierarchical location in the network of the network incident (such as a domain, a zone, affected component(s), etc.).

Then, the computer system may update, based at least in part on the user feedback, the pretrained predictive model (operation 212) that outputs severity classifications of network incidents, where a difference between a severity classification of the updated pretrained predictive model and a user severity classification associated with the user feedback is reduced relative to an initial difference between an initial severity classification of the pretrained predictive model and the user severity classification. Note that the pretrained predictive model and/or the updated pretrained model may include: a neural network, a supervised machine-learning model, and/or another type of predictive model. In some embodiments, the pretrained predictive model and/or the updated pretrained predictive model may include a classifier or a regression model. Consequently, a given severity classification may include categorical information or numerical values (such as numerical values between 0 and 1).

In some embodiments, the computer system may optionally perform one or more additional operations (operation 214). For example, the computer system may receive information specifying a second network incident. Next, the computer system may compute a second severity classification of the second network incident using the updated pretrained predictive model. Furthermore, the computer system may determine a priority on the second network incident based at least in part on the second severity classification. Additionally, the computer system may perform a remedial action based at least in part on the second severity classification and/or the priority. For example, the remedial action may include: changing a network configuration, correcting a component failure in the network (such as a failure of an access point or a computer network device, e.g., a switch or a router), correcting a VLAN mismatch failure, and/or otherwise correcting the second network incident. In some embodiments, the computer system may compute a third severity classification of the second network incident using a general pretrained predictive model that is associated with multiple users, and the priority and/or the remedial action may be based at least in part on the third severity classification.

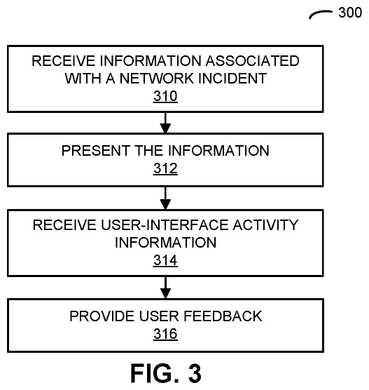

FIG. 3 presents an example of a flow diagram illustrating an example method 200 for providing user feedback. Note that method 300 may be performed by an electronic device, such as electronic device 110-1.

During operation, the electronic device may receive, from a computer system, information associated with a network incident (operation 310) in a network. Then, the electronic device may present the information (operation 312), e.g., the information may be displayed in a user interface on a display. Moreover, the electronic device may receive user-interface-activity information (operation 314), wherein the user-interface-activity information specifies user feedback about a severity of the network incident. Next, the electronic device may provide, addressed to the computer system, the user feedback (operation 316).

In some embodiments of methods 200 (FIG. 2) and/or 300, there may be additional or fewer operations. Moreover, there may be different operations. Furthermore, the order of the operations may be changed, and/or two or more operations may be combined into a single operation.

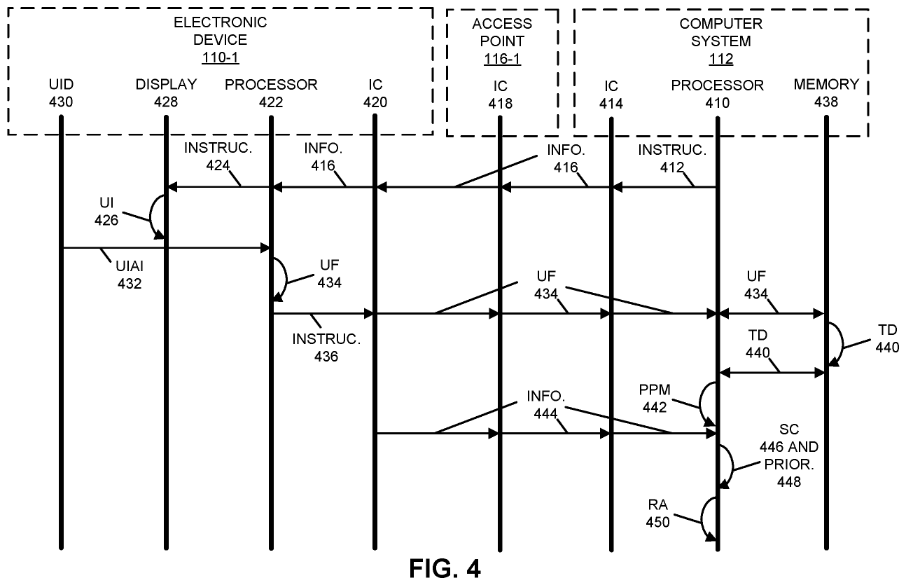

FIG. 4 presents a drawing illustrating an example of communication between electronic device 110-1, access point 116-1 and computer system 112. In FIG. 4, a processor 410 in computer system 112 may instruct 412 an interface circuit (IC) 414 in computer system 112 to provide information 416 specifying one or more network incidents to electronic device 110-1 via interface circuit 418 in access point 116-1.

After receiving information 416, an interface circuit 420 in electronic device 110-1 may provide information 416 to a processor 422 in electronic device 110-1. This processor may provide instructions 424 for a user interface (UI) 426 that includes information 416 to a display 428 in electronic device 110-1. Next, display 428 may display user interface 426.

A user of electronic device 110-1 may interact with a user-interface device (UID) 430 in electronic device 110-1 to provide user-interface-activity information (UIAI) 432 that specifies user feedback (UF) 434 about the one or more network incidents. After receiving the user-interface-activity information 432 and determining user feedback 434 from the user-interface-activity information 432, processor 422 may instruct 436 interface circuit 420 to provide user feedback 434 to computer 112 via access point 116-1.

Moreover, after receiving user feedback 434, interface circuit 414 may provide user feedback 434 to processor 410. Then, processor 410 may include or incorporate user feedback 434 into a training dataset 440 in memory 438 in computer system 112. Next, processor 410 may update a pretrained predictive model (PPM) 442 using a supervised-machine learning technique and training dataset 440.

Subsequently, interface circuit 414 may receive information 444 specifying another network incident, e.g., from access point 116-1. Interface circuit 414 may provide information 444 to processor 410. Then, processor 410 may use the updated pretrained predictive model 442 to compute a severity classification (SC) 446 and/or a priority 448 of the other network incident based at least in part on information 440. Moreover, processor 410 may perform a remedial action (RA) 450 based at least in part on the severity classification 446 and/or the priority 448.

While FIG. 4 illustrates some operations using unilateral or bilateral communication (which are, respectively, represented by one-sided and two-sided arrows), in general a given operation in FIG. 4 may involve unilateral or bilateral communication.

We now further describe the communication techniques. One of the main goals for anomaly detection systems is to reduce time and manpower in troubleshooting incidents and incident severity plays a major role in this. Incident severity can have significant impact on users' time, understanding of overall network health and/or trust in products (such as access points, controllers, etc.). Understanding the severity of a network incident is often a complicated problem and may depend on a variety of factors, such as: a size of a network, the type of clients in the network, a location and/or user categorization of the network incident. Note that a ‘network incident’ may include an anomaly in the function of at least a component or a portion of a wired or wireless network that may degrade network or communication performance for network clients or users.

In the disclosed communication techniques, a network-incident feedback cycle may be used to dynamically update pretrained predictive model(s) that determines a severity classification of a network incident based at least in part on characteristics of the network incident. For example, the characteristics of the network incident may include: an incident category (such as infrastructure), an incident sub-category (such as VLAN mismatch), an incident type (such as ‘switch group’), an incident scope (such as ‘density’), an incident duration, an incident start time, and/or an incident end time. Note that the pretrained predictive model(s) may include: a pretrained general or vertical predictive model (which may be based at least in part on user feedback about incident severity from multiple users, e.g., users in the same vertical or market segment as the user, such as hospitality or education) and/or a pretrained user-specific predictive model (which may be based at least in part on user feedback about incident severity from a specific user, company or organization). The pretrained general or vertical predictive model may be used when user feedback from a user is unavailable.

When a network incident occurs, the characteristics of the network incident may be presented to one or more users and the one or more users may be requested to provide user feedback about a severity of the network incident. For example, the user feedback may indicate a severity rating for the network incident (such as on a scale of 1-5) or may indicate one of a set of predefined categories (such as severe, moderately important or unimportant). In some embodiments, the user feedback may assign a color code to the network incident, such as red (for severe), yellow (for moderate) or green (for unimportant). Thus, in some embodiments, the user feedback may be associated with color-coded categories. Alternatively, the user interface may indicate a current severity classification for a network incident, and the user feedback may indicate whether or not the current severity classification is accurate (such as more severe, less severe, or correct).

The user feedback may be used to update or retrain one or more of the pretrained predictive model(s), thereby improving the accuracy of severity classifications, from the user perspective, for subsequent network incidents. In these ways, one or more of the pretrained predictive model(s) may be incrementally updated or tuned based at least in part on user feedback corresponding to the perspective of one or more users about the severity or importance of network incidents.

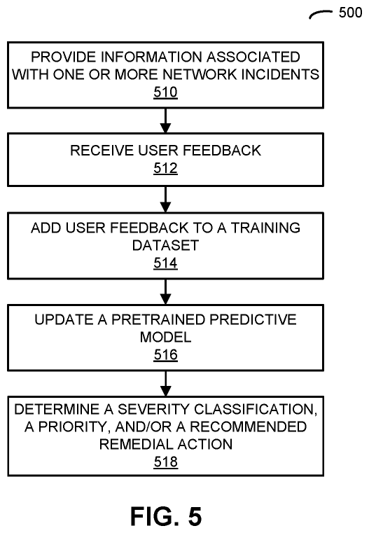

FIG. 5 presents a drawing illustrating an example method 500 for dynamically updating a predictive model. In this method, information associated with one or more network incidents may be provided to one or more users (operation 510). For example, the information may be presented to the one or more users in instances of a user interface. Then, the one or more users may submit user feedback about the network-incident severity and/or additional metadata (e.g., information specifying a priority of the network incident and/or a suggested remedial action to perform in response to the network incident). After being received (operation 512) by an application programing interface (API) module, this user feedback may be added to a training dataset (operation 514). Next, a machine-learning module may use the training dataset to retrain or update at least a pretrained predictive model (operation 516), such as an anomaly detection module. Moreover, the updated pretrained predictive model in the anomaly detection module may be used to determine a severity classification, a priority and/or a recommended remedial action (operation 518) for a subsequent network incident. Note that these operations may be repeated: periodically or after a time interval, as needed (e.g., based at least in part on the performance of the pretrained predictive model, such as difference between the predictions of the pretrained predictive model and the user feedback from the one or more users), or continuously (e.g., whenever a network incident occurs). Consequently, the communication techniques may be used to dynamically update the pretrained predictive model.

FIG. 6 presents a drawing illustrating an example of a user interface 600 that receives user feedback about a network incident. This user interface may present characteristics associated with a network incident and may allow a user to provide user feedback about the network incident, such as a severity classification of the network incident.

In general, the user feedback may allow the severity of a network incident from the perspective of a user to be better understood. This may allow improved responses to network incidents. Moreover, by providing an improved understanding of the severity of network incidents in different networks, the communication techniques may improve the response time to network incidents and/or may facilitate faster product development cycles that provide improved customer satisfaction. Furthermore, the communication techniques may allow the requests to be improved or focused on the network incidents that are most likely to be important to users. Similarly, the user feedback may allow data patterns that should not be converted or identified as network incidents to be determined and/or may allow pretrained predictive model(s) to be dynamically updated.

We now describe embodiments of an electronic device, which may perform at least some of the operations in the communication techniques. For example, the electronic device may include a component in FIG. 1, such as one of: one or more of electronic devices 110, one or more of access points 116, one or more of radio nodes 118, and/or computer system 112. FIG. 7 presents a block diagram illustrating an electronic device 700 in accordance with some embodiments. This electronic device includes processing subsystem 710, memory subsystem 712, and networking subsystem 714. Processing subsystem 710 includes one or more devices configured to perform computational operations. For example, processing subsystem 710 can include one or more microprocessors, ASICs, microcontrollers, programmable-logic devices, graphical processor units (GPUs) and/or one or more digital signal processors (DSPs). Note that one or more components in processing subsystem 710 are, individually or collectively, sometimes referred to as a computation device.

Memory subsystem 712 includes one or more devices for storing data and/or instructions for processing subsystem 710 and networking subsystem 714. For example, memory subsystem 712 can include dynamic random access memory (DRAM), static random access memory (SRAM), and/or other types of memory (which collectively or individually are sometimes referred to as a ‘computer-readable storage medium’). In some embodiments, instructions for processing subsystem 710 in memory subsystem 712 include: one or more program modules or sets of instructions (such as program instructions 722 or operating system 724), which may be executed by processing subsystem 710. Note that the one or more computer programs may constitute a computer-program mechanism. Moreover, instructions in the various modules in memory subsystem 712 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 710.

In addition, memory subsystem 712 can include mechanisms for controlling access to the memory. In some embodiments, memory subsystem 712 includes a memory hierarchy that comprises one or more caches coupled to a memory in electronic device 700. In some of these embodiments, one or more of the caches is located in processing sub system 710.

In some embodiments, memory subsystem 712 is coupled to one or more high-capacity mass-storage devices (not shown). For example, memory subsystem 712 can be coupled to a magnetic or optical drive, a solid-state drive, or another type of mass-storage device. In these embodiments, memory subsystem 712 can be used by electronic device 700 as fast-access storage for often-used data, while the mass-storage device is used to store less frequently used data.

Networking subsystem 714 includes one or more devices configured to couple to and communicate on a wired and/or wireless network (i.e., to perform network operations), including: control logic 716, an interface circuit 718 and one or more antennas 720 (or antenna elements). (While FIG. 7 includes one or more antennas 720, in some embodiments electronic device 700 includes one or more nodes, such as nodes 708, e.g., a pad or a connector, which can be coupled to the one or more antennas 720. Thus, electronic device 700 may or may not include the one or more antennas 720.) For example, networking subsystem 714 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 700 may be adapted or changed using pattern shapers (such as reflectors) in one or more antennas 720 (or antenna elements), which can be independently and selectively electrically coupled to ground to steer the transmit antenna radiation pattern in different directions. Thus, if one or more antennas 720 includes N antenna-radiation-pattern shapers, the one or more antennas 720 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 700 may use the mechanisms in networking subsystem 714 for performing simple wireless communication between the electronic devices, e.g., transmitting frames and/or scanning for frames transmitted by other electronic devices.

Within electronic device 700, processing subsystem 710, memory subsystem 712, and networking subsystem 714 are coupled together using bus 728. Bus 728 may include an electrical, optical, and/or electro-optical connection that the subsystems can use to communicate commands and data among one another. Although only one bus 728 is shown for clarity, different embodiments can include a different number or configuration of electrical, optical, and/or electro-optical connections among the subsystems.

In some embodiments, electronic device 700 includes a display subsystem 726 for displaying information on a display, which may include a display driver and the display, such as a liquid-crystal display, a multi-touch touchscreen, etc.

Electronic device 700 can be (or can be included in) any electronic device with at least one network interface. For example, electronic device 700 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 700, in alternative embodiments, different components and/or subsystems may be present in electronic device 700. For example, electronic device 700 may include one or more additional processing subsystems, memory subsystems, networking subsystems, and/or display subsystems. Additionally, one or more of the subsystems may not be present in electronic device 700. Moreover, in some embodiments, electronic device 700 may include one or more additional subsystems that are not shown in FIG. 7. Also, although separate subsystems are shown in FIG. 7, in some embodiments some or all of a given subsystem or component can be integrated into one or more of the other subsystems or component(s) in electronic device 700. For example, in some embodiments program instructions 722 are included in operating system 724 and/or control logic 716 is included in interface circuit 718.

Moreover, the circuits and components in electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 714 or electronic device 700. The integrated circuit may include hardware and/or software mechanisms that are used for transmitting wireless signals from electronic device 700 and receiving signals at electronic device 700 from other electronic devices. Aside from the mechanisms herein described, radios are generally known in the art and hence are not described in detail. In general, networking subsystem 714 and/or the integrated circuit can include any number of radios. Note that the radios in multiple-radio embodiments function in a similar way to the described single-radio embodiments.

In some embodiments, networking subsystem 714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), Open Access (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 722, operating system 724 (such as a driver for interface circuit 718) or in firmware in interface circuit 718. Alternatively or additionally, at least some of the operations in the communication techniques may be implemented in a physical layer, such as hardware in interface circuit 718.

Moreover, while the preceding discussion used network incidents that adversely impact communication performance in a network as an illustration of the communication techniques, in other embodiments the communication techniques may be used with a wide variety of network incidents and/or more-general types of incidents. For example, the types of incidents may include cybersecurity, spam, or failure or service disruption in a utility (such as in a power delivery network, a water supply, etc.). Notably, a user may be requested to provide user feedback about a cybersecurity event from the perspective of the user. This user feedback may be used to update a pretrained predictive model that assesses severities of cybersecurity events, e.g., based at least in part on characteristics associated with the cybersecurity events and/or the impact on a network or a computer system. Then, when another cybersecurity event occurs or is detected, the updated predictive model may be used to determine a severity of the other cybersecurity event, a priority associated with the other cybersecurity event and/or one or more recommended remedial actions.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a computation device electrically coupled to the interface circuit; and
memory, electrically coupled to the computation device, that stores program instructions, wherein, when executed by the computation device, the program instructions cause the computer system to perform operations comprising:
receiving, associated with the electronic device, information specifying user feedback about a network incident; and
updating, based at least in part on the user feedback, a pretrained predictive model configured to output severity classifications of network incidents, wherein a difference between a severity classification of the updated pretrained predictive model and a user severity classification associated with the user feedback is reduced relative to an initial difference between an initial severity classification of the pretrained predictive model and the user severity classification.

2. The computer system of claim 1, wherein the network incident comprises an event having an adverse impact on communication performance in at least a portion of a network.

3. The computer system of claim 1, wherein the operations comprise:
receiving information specifying a second network incident;
computing a second severity classification of the second network incident using the updated pretrained predictive model;
determining a priority on the second network incident based at least in part on the second severity classification; and
performing a remedial action based at least in part on the second severity classification, the priority or both.

4. The computer system of claim 3, wherein the remedial action comprises: changing a network configuration, correcting a component failure in the network, correcting a VLAN mismatch failure, or otherwise correcting the second network incident.

5. The computer system of claim 3, wherein the operations comprise computing a third severity classification of the second network incident using a general pretrained predictive model that is associated with multiple users, and the priority, the remedial action or both is based at least in part on the third severity classification.

6. The computer system of claim 1, wherein the pretrained predictive model, the updated pretrained model or both comprise: a neural network, a supervised machine-learning model, or another type of predictive model.

7. The computer system of claim 1, wherein the pretrained predictive model, the updated pretrained predictive model or both comprise a classifier or a regression model.

8. The computer system of claim 1, wherein the user feedback comprises: a score or a ranking corresponding to the user severity, a scope of the network incident, a type of the network incident, a physical location in the network of the network incident, or a hierarchical location in the network of the network incident.

9. The computer system of claim 1, wherein the computation device comprises a processor or a graphical processor unit.

10. A non-transitory computer-readable storage medium for use in conjunction with a computer system, the computer-readable storage medium storing program instructions, wherein, when executed by the computer system, the program instructions cause the computer system to perform one or more operations comprising:
receiving, associated with the electronic device, information specifying user feedback about a network incident; and
updating, based at least in part on the user feedback, a pretrained predictive model configured to output severity classifications of network incidents, wherein a difference between a severity classification of the updated pretrained predictive model and a user severity classification associated with the user feedback is reduced relative to an initial difference between an initial severity classification of the pretrained predictive model and the user severity classification.

11. The non-transitory computer-readable storage medium of claim 10, wherein the network incident comprises an event having an adverse impact on communication performance in at least a portion of a network.

12. The non-transitory computer-readable storage medium of claim 10, wherein the operations comprise:
receiving information specifying a second network incident;
computing a second severity classification of the second network incident using the updated pretrained predictive model;
determining a priority on the second network incident based at least in part on the second severity classification; and
performing a remedial action based at least in part on the second severity classification, the priority or both.

13. The non-transitory computer-readable storage medium of claim 12, wherein the operations comprise computing a third severity classification of the second network incident using a general pretrained predictive model that is associated with multiple users, and the priority, the remedial action or both is based at least in part on the third severity classification.

14. The non-transitory computer-readable storage medium of claim 10, wherein the pretrained predictive model, the updated pretrained model or both comprise: a neural network, a supervised machine-learning model, or another type of predictive model.

15. The non-transitory computer-readable storage medium of claim 10, wherein the user feedback comprises: a score or a ranking corresponding to the user severity, a scope of the network incident, a type of the network incident, a physical location in the network of the network incident, or a hierarchical location in the network of the network incident.

16. A method for updating a pretrained predictive model, comprising:
by a computer system:
receiving, associated with the electronic device, information specifying user feedback about a network incident; and
updating, based at least in part on the user feedback, the pretrained predictive model that outputs severity classifications of network incidents, wherein a difference between a severity classification of the updated pretrained predictive model and a user severity classification associated with the user feedback is reduced relative to an initial difference between an initial severity classification of the pretrained predictive model and the user severity classification.

17. The method of claim 16, wherein the method comprises:
receiving information specifying a second network incident;
computing a second severity classification of the second network incident using the updated pretrained predictive model;
determining a priority on the second network incident based at least in part on the second severity classification; and
performing a remedial action based at least in part on the second severity classification, the priority or both.

18. The method of claim 17, wherein the method comprises computing a third severity classification of the second network incident using a general pretrained predictive model that is associated with multiple users, and the priority, the remedial action or both is based at least in part on the third severity classification.

19. The method of claim 16, wherein the pretrained predictive model, the updated pretrained model or both comprise: a neural network, a supervised machine-learning model, or another type of predictive model.

20. The method of claim 16, wherein the user feedback comprises: a score or a ranking corresponding to the user severity, a scope of the network incident, a type of the network incident, a physical location in the network of the network incident, or a hierarchical location in the network of the network incident.
